(19) United States
(12) Patent Application Publication
(10) Pub. No.: US 2024/0246438 A1
(43) Pub. Date: Jul. 25, 2024

(54) METHOD AND DEVICE FOR DETERMINING A POSITION AND ORIENTATION OF A SOCKET OF AN ELECTRIC VEHICLE

(71) Applicant: Rocsys B.V., Rijswijk (NL)

(72) Inventors: Kanter van Deurzen, Delft (NL); Johannes Oosten van der Weijde, Delft (NL)

(21) Appl. No.: 18/289,356

(22) PCT Filed: May 6, 2022
(86) PCT No.: PCT/EP2022/062233

§ 371 Date: Nov. 2, 2023

(30) Foreign Application Priority Data
May 6, 2021 (NL) N2028169

(51) Int. Cl. B60L 53/36; B60L 53/16

(52) U.S. Cl. CPC B60L 53/36; B60L 53/16

(57) ABSTRACT

Determining a position and orientation of a socket of an electric vehicle, the socket adapted for plugging in a charging connector in one unique plug-in position with one unique plug-in orientation and in one unique plug-in direction, as well as a front plane and/or a fiducial marker having an optical gravity point, includes providing a 2D camera with a view on a vehicle's charging location having a camera view comprising view lines for providing a 2D image of a focal plane perpendicular to said central view line, bringing the socket within said camera view, defining a view line going through the optical gravity point on the socket as the line of sight, viewing the socket with the camera, obtaining a 2D image, and analyzing the 2D image, wherein the vehicle and the camera are mutually positioned such that the line of sight is under an angle with the plug-in direction.

The present invention relates to a method and device for determining a position and orientation of a socket of an electric vehicle. More in particular, the invention relates to a method and device for doing so in an automated manner, with the purpose of automatically connecting a charging connector to the vehicle's socket.

There is a constant aim in automating all handling regarding the charging of electric vehicles. Various attempts were made with wireless charging systems, but conductive charging remains preferred for reasons of technical simplicity and energetic efficiency. However, connecting a charger connector to the vehicle's socket may still be considered cumbersome. Especially in the case of large fleet owners, it may be considered beneficial when the physical connection of the vehicle is done automatically.

The challenge in making this physical connection is the exact positioning of the connector in the socket before plugging it in. This has to be done with an accuracy in the range smaller than a few millimetres, which implies that the accuracy is met by the device for plugging the connector in, and not by a vehicle, which at present cannot be positioned automatically with an accuracy of a few centimetres.

In order to connect vehicles at a reasonable speed, the positioning of the charger needs to be as fast as possible, but under safe conditions and without damaging the vehicle. This requires a detailed determination of the socket position and orientation. Determining the position and orientation in six degrees of freedom (6DOF) is typically done with multiple cameras or 3D viewing techniques. However, they are usually spacious and not always economically feasible.

There are also solutions using a single 2D camera. However, making sure that the position and orientation of the socket is always determined with the required accuracy remains a challenge.

The article “A robotic charging scheme for electric vehicles based on monocular vision and force perception”, published in IEEE Proceedings of Dec. 6, 2019, pages 2958-2963 discloses a system wherein a camera and a connector are rigidly connected to an end-effector of a robot. It mentions an L-shape motion of the connector towards the ‘approach position’, based on pose estimation from a camera image. This does mean that the camera must have a position relative to the socket for recording an image (the article calls this the starting position), but it does not mention what this relative position is, and there is no mention of positioning of either camera or socket while using prior knowledge on socket position or orientation before recording an image. After analysing the image, they align the connector with the socket.

So in contrast with this invention, this article does not explicitly mention any positioning of the camera relative to the socket (or vice versa), so also not alignment or intentional misalignment of the camera with respect to a socket, especially not by moving the camera, not to mention based on earlier obtained information like image analysis.

US 2021 086643 discloses a system wherein the plug-in direction and the orthogonal axis through the plane of the to-be-recognized fiducial features do not have to be aligned. Moreover, it does not require the camera to have a view on the socket when obtaining a 2D image.

It is a goal of the present invention to take away the disadvantages of the prior art and/or to provide a useful alternative to the prior art.

The invention thereto proposes a method for determining a position and orientation of a socket of an electric vehicle, the socket adapted for plugging in a charging connector in one unique plug-in position with one unique plug-in orientation and in one unique plug-in direction, the socket having a front plane with an optical gravity point; the method comprising the steps of:
Providing a 2D camera with a view on a charging location for an electric vehicle; said 2D camera:
   having a camera view comprising view lines, each extending around a central view line originating from a camera pinhole within a maximum angle deviation around said central view line;
   adapted for providing a 2D image,
Bringing the socket for plugging in a charging connector of the electric vehicle within said camera view;
Defining a view line going through the optical gravity point on the socket as the line of sight;
Viewing the socket with the camera and obtaining a 2D image;
Analysing the 2D image with a 3D pose estimation algorithm for obtaining a position and/or orientation of the socket with respect to the camera pinhole;
   wherein:
The vehicle and the camera are intentionally mutually positioned such that the line of sight is under an angle with the plug-in direction before obtaining the 2D image, which angle is maintained during obtaining the 2D image.

The method according to the invention may comprise positioning the vehicle and the camera such that the line of sight is under a known and/or predetermined angle with the plug-in direction.

A 3D pose estimation algorithm may include a combination of a feature recognition algorithm to detect purposive or purposeful fiducial markers, and an algorithm to estimate the pose, given the recognized fiducial features of the fiducial marker. A description hereof is also given in the Dutch patent application NL2030458, which is incorporated by reference.

A feature recognition algorithm may for example be a convolutional neural network algorithm or an algorithm based on a “You Only Look Once” (YOLO) model.

A pose estimation algorithm may for example be a perspective-n-point (PnP) algorithm (such as SolvePnP) or a random sample consensus (ransac) algorithm. In general, a fiducial marker is composed of one or multiple fiducial features, which are recognizable by their shape, contrast, colour or the like. Suitable aspects are typically gradients or abrupt transitions (edges), which may constitute lines, curves or corners, or other complex visual features.

A purposeful fiducial marker may be, for example, a QR code, an April tag or the like, or a geometrical feature with being recognized as its main purpose.

A purposive fiducial marker, in this context, may be or form part of the connecting functionality of the socket, which may comprise features of a charging socket with a documented geometry, for example defined in an international standard such as IEC 62196 or in another design specification, that are visible in recordings. The connecting functionality may be formed of or comprise socket parts for electrically and/or mechanically and/or physically coupling a connector. Electrically insulating parts may be comprised as well. The (inverse) shape for receiving the connector in general may be seen as connecting functionality, as well as the conductive pins, and non-conductive body specifically.

When using a 2D camera to estimate the pose of a socket, and intentionally placing the camera and socket such that in the recorded image the front plane of the socket effectively has an angle about at least one axis orthogonal to the line of sight, the estimation of the angle about that axis improves.

Doing this intentionally means purposefully bringing the socket for plugging in a charging connector of electric vehicle within said camera view such that the line of sight is under an angle with the plug-in direction, based on prior knowledge of the position and/or orientation of the socket. This prior knowledge may be a previous recording, data from other sensors than the camera (f.e. a distance sensor), or by design of vehicle and infrastructure (f.e. forcing a specific parking position and orientation of a specific vehicle with respect to the camera, by means of lines, blocks, rails and the like).

In practice, it is preferred that the socket, that is in particular mostly a plane touching its surface—in the thus obtained image is rotated about at least one axis orthogonal to the line of sight. A rotation around the line of sight alone is not beneficial. Using an alternative front plane or alternative fiducial marker is also possible. In particular, when using a general fiducial marker (including the socket itself), the front plane is defined as the plane where the features of the fiducial marker would be most visible in a 2D image. I.e. for a 2D fiducial marker on a flat surface, the front plane is the one parallel to, or coinciding with that surface.

More in particular, when using a socket as fiducial marker, an axis orthogonal to the front plane is essentially parallel with the plug-in direction.

In other words, according to the invention, when taking a 2D image of the front plane, the view line from the camera to the optical gravity point has an angle with respect to the axis orthogonal to the front plane.

In any case, the axis orthogonal to the front plane should essentially be parallel to the plug-in direction. This means the angle between these two axes should preferably be smaller than 15 degrees, more preferably be smaller than 7 degrees, and most preferably be smaller than 5 degrees. Having these axes essentially parallel is beneficial for applications of this method when the socket is located on the side body (or front or rear) of vehicles.

When applying the method according to the invention, it may be assumed that a rough estimate of the position can be made upfront, and/or there are means for bringing the socket into the camera view, for instance by moving the camera. It is to be noticed that the maximum angle deviation around said central view line does not have to be a constant angle. The total “bundle” of angles—as a result—doesn't have to have a cone-shape. It may have an oval or even rectangular cross section.

The optical gravity point can in fact be chosen randomly, but a logical choice may be within the convex hull of the to-be-recognized features, for instance within the convex hull of the pins of a socket, for instance for a CCS-2 socket a central point between two DC contactors, on the front plane of the socket, or a central (data) pin of the AC connectors. The choice depends on the type of features used for recognition. In particular the optical gravity point is the centroid of the convex hull of the to-be-recognized features, in particular the centroid of the convex hull of the pins of a socket.

The choice of the optical gravity point on the socket as described above may be determined based on at least one purposive or purposeful fiducial marker, in particular formed by at least part of the socket or being a point within a convex hull of the socket and/or a purposeful marker like a QR code or any other means for recognizing it relatively easy by software, wherein the purposeful marker is located on a plane essentially parallel to the front plane. This marker may be applied on the socket especially for this purpose, but also be inherently present in the socket, for instance by pins or holes in a certain pattern and at known distances from each other. The optical gravity point may be the centroid of the convex hull of the to-be-recognized features.

The step of positioning a vehicle with its socket for a charger connector within said camera view, such that the line of sight is under an angle with the plug-in direction may be done by positioning the vehicle at a predetermined position as accurate as possible. This is most useful for known vehicles, in particular fleets, for example busses, or taxis, or where the guidance is adapted based on the approaching vehicle. To enable this, the infrastructure may contain guiding features such that the EV can be parked or parks itself at an intended position and in an intended orientation with respect to a charging connector and/or a 2D camera placed in the vicinity of said charging connector. Such charging connector may be automatically movable within a certain area.

Alternatively, the step of positioning a vehicle with its socket for a charger connector within said camera view, such that the line of sight is under an angle with the plug-in direction may be done by moving the vehicle based on an estimated position and/or orientation of the vehicle. Moving the vehicle can for instance be done by sending the vehicle instructions to move, based on a first estimated position. This first estimate could be made by a similar means as described above, but may also result from other detection means, like a distance sensor between the socket and a reference point on the infrastructure. The method according to the invention may thereto comprise sending instructions to the vehicle for moving itself. This is possible if the vehicle is configured for (wireless) communication and when it either autonomously responds on this feedback, or when it can be remotely controlled. As an alternative, instructions may be provided to the vehicle's driver.

In a preferred embodiment however, the camera is moved based on a known or estimated position and/or orientation of the vehicle. In this embodiment, the vehicle may be parked in the vicinity of a parking charging infrastructure, comprising a charger and means for moving a charging connector to a vehicle's socket and plugging it in. In order to bring the socket for plugging in a charging connector of the electric vehicle within the camera view, the electric vehicle is parked such that the socket is in view, or that the socket comes in view by moving the camera. Optionally, a picture is then taken in order to roughly estimate the socket's position and/or orientation, or by using another detection means, like a distance sensor between the socket and a reference point on the infrastructure. As a next step, the camera is then moved based on this rough estimation, such that the line of sight is under an angle with the plug-in direction, in order to obtain a new, more accurate estimate.

The effective move may preferably be a translation, in order to keep the practical realisation the least complex. In general, moving the camera along a straight line has the effect of rotating the line of sight with respect to the plug-in direction, and thus changing the view and the 2D image obtained, with the exception being a translation purely along the line of sight. A composed movement is an option too, wherein a combination of rotations and translations has the desired effect. However, purely rotating does not achieve the desired effect as, while this does change the line of sight with respect to the central view, it does not change the angle between the line of sight and the plug-in direction.

In order to increase the accuracy, preferably the angle is between 5 and 60 degrees, and more preferably between 7 and 45 degrees and most preferably about 15 degrees. Slight variations in the angle around an angle of 0° are hard to notice, so estimating angles around 0° is sensitive to noise. However, at an angle of 90° the front face of the socket is aligned with the line of sight, so it is no longer visible on the 2D image. Furthermore, the larger the angle, the smaller the socket becomes in terms of pixels on the 2D camera view. In other words, when increasing the angle, the visibility of surfaces on the front plane reduces. I.e. in the 2D recording the surface reduces to a line when approaching 90 degrees. However, at a 90 degrees angle the gradient of the visible width of a surface is the largest, so the pose estimation algorithm would be the most sensitive. A trade off results, providing the mentioned angles as the experimentally determined optimum.

The above angles have been determined experimentally to form an optimum in the trade off between the visibility (or size) of recognizable features in the 2D recording versus the sensitivity in determining the socket's orientation.

As an example to obtain the angle by translation, a difference of 5 degrees corresponds with about a 5 cm translation orthogonal to the plug-in direction with the camera positioned at a bit over 55 cm in the plug-in direction. This is roughly the width of a CCS socket, or half its height.

The determination of the position and orientation of the socket for the purpose of plugging the charging connector may preferably be based on a single image. That means, for calculation of position and orientation a single image is used. However, multiple 2D pictures may be taken without changing the vehicle or camera position, and each 2D image may then be used for determining the socket position and orientation, after which an average orientation and position is determined. This may lead in some circumstances to a better determined position and orientation.

The method according to the invention may further comprise at least one step of repeatedly obtaining a 2D image with the socket and the camera in the same mutual position and orientation to average out errors or repeatedly estimating socket position to average out errors or obtaining a 2D image, with an enlarged or optically or physically zoomed in view, for obtaining a more accurately determined position and/or orientation.

Alternatively or additionally, the method according to the invention may comprise iterations of the determination of the position and/or orientation of the socket using a 2D image, with the socket and the camera in a changing mutual position and orientation, wherein the vehicle or camera is moved in between taking the images.

In other words, the step of bringing the socket for plugging in a charging connector of the electric vehicle within said camera view, such that the line of sight is under an angle with the plug-in direction comprises moving the camera based on an estimated position and/or orientation of the socket, the method further comprising iteratively determining a socket position and orientation based on multiple 2D images taken with both the socket and the camera in different mutual positions, in particular wherein the camera position and orientation for one 2D image is changed based on information derived from a previous 2D image. The camera may be coupled to, or be moved simultaneously with the connector, when plugging in the connector into the socket.

A distance between the 2D camera and the socket may in an embodiment be decreased during iteration as described above, or during plugging in the connector in general. By approaching the socket, a more precise determination of the socket's position and/or orientation may take place.

The determination of the socket's position and/or orientation may yet be improved by illuminating the socket, in particular in cases wherein it is in a shade, or at night.

The 2D image may in a further embodiment be used for collision monitoring of an area around the socket, in order to plug in a connector without collisions. Collisions may otherwise for instance take place with a lid of the socket, which may be hinged aside, or with other objects or car parts being in the vicinity of the socket.

The method according to the invention may further comprise measuring a distance between the socket and a reference point, such as the camera or a connector, by means of a distance sensor. The information obtained from such sensor helps to determine the socket's position and orientation more precisely and possibly also faster.

The invention also relates to a device for connecting a connector for charging an electric vehicle to a socket, comprising at least one 2D camera, positioned with a view on a charging location for an electric vehicle; said 2D camera having a camera view comprising view lines, each extending around a central view line originating from a camera pinhole within a maximum angle deviation around said central view line adapted for providing a 2D image, in particular with a focus on a plane perpendicular to said central view line, processing means, configured for defining a line of sight being the view line going through the optical gravity point on the socket in case a vehicle with a socket for a charger connector is positioned within said camera view, viewing a positioned socket with the camera and obtaining a 2D image, analysing the 2D image with a 3D pose estimation algorithm for obtaining a position and/or orientation of the socket with respect to the camera pinhole, wherein the processing means are configured for determining whether a vehicle and the camera are mutually positioned such that the line of sight is under an angle with the plug-in direction.

The device according to the invention may further comprise means for bringing the socket for plugging in a charging connector of the electric vehicle within said camera view. This may for instance be a marking of a parking spot, or physical stops, blocks, notches or similar limiters for a vehicle's movement, communication means for direct communication with the vehicle for providing parking instructions, or communication means for communication with a driver of the vehicle.

The means for positioning a vehicle with its socket for a charger connector within said camera view may comprise means for moving the camera. The device may further comprise a charging connector and means for positioning said connector. The camera may be mechanically coupled to the means for positioning the connector and be displaceable with respect to the connector, in particular in the driving direction of the vehicle. Alternatively, the camera may be rigidly placed with respect to the charging location, and the processing means may comprise communication means for sending drive or positioning instructions to a vehicle.

The device according to the invention may further comprise illumination means, such as a light source or spot, for illuminating the socket. Alternatively the vehicle may comprise a light for illuminating its socket.

The device may further be configured for using the 2D image for collision monitoring of an area around the socket, in order to plug in a connector without collisions. Collisions may otherwise take place with for instance a lid of the socket, or other protruding parts of the vehicle, or the area surrounding it.

The device according to the invention may further comprise a distance sensor, for determining a distance between the socket and a reference point on the infrastructure, such as the camera or a connector.

The invention will now be elucidated into more detail with reference to the following figures, wherein:

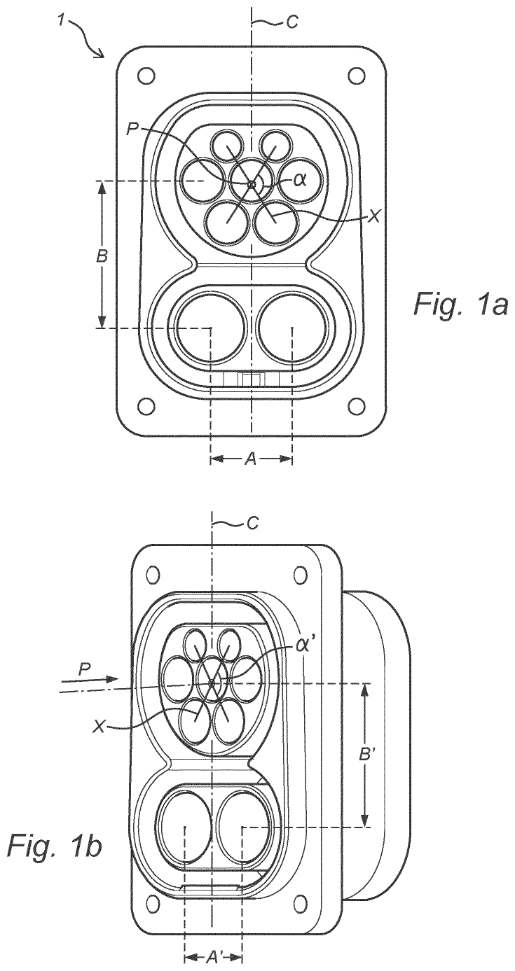

FIGS. 1a, b show two views of a socket for a charging connector;

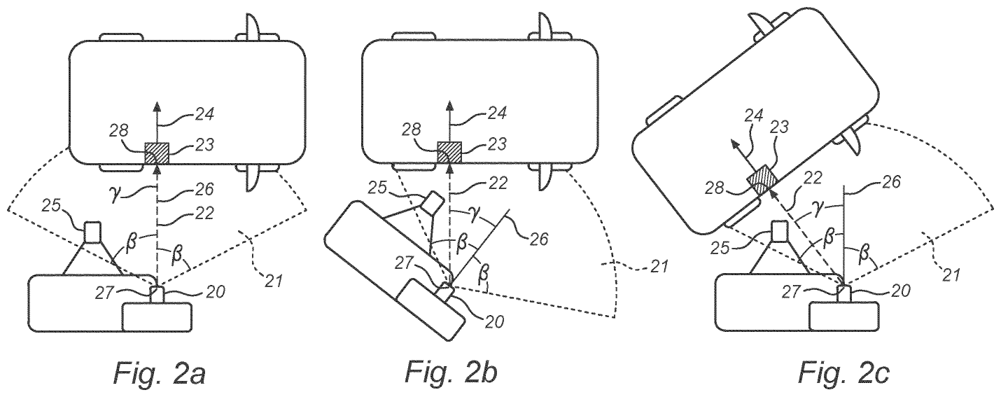

FIGS. 2a, b, c schematically show mutual orientations of sockets and cameras, not according to the invention;

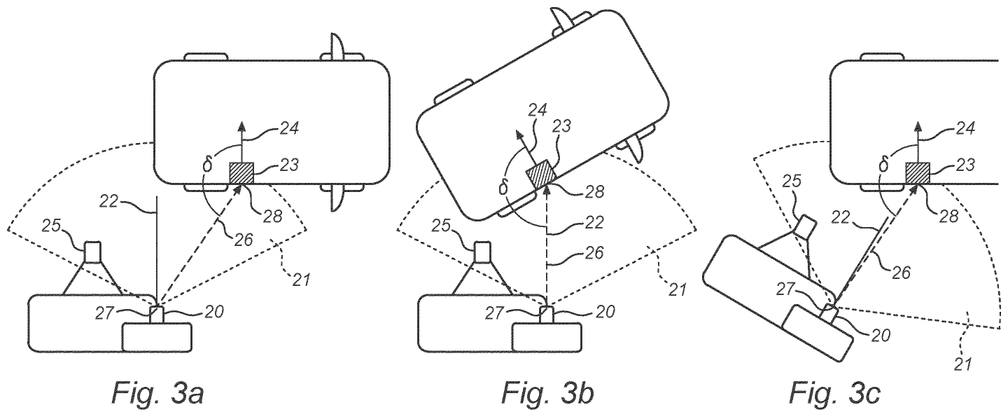

FIGS. 3a, b, c schematically show mutual orientations of sockets and cameras according to the invention;

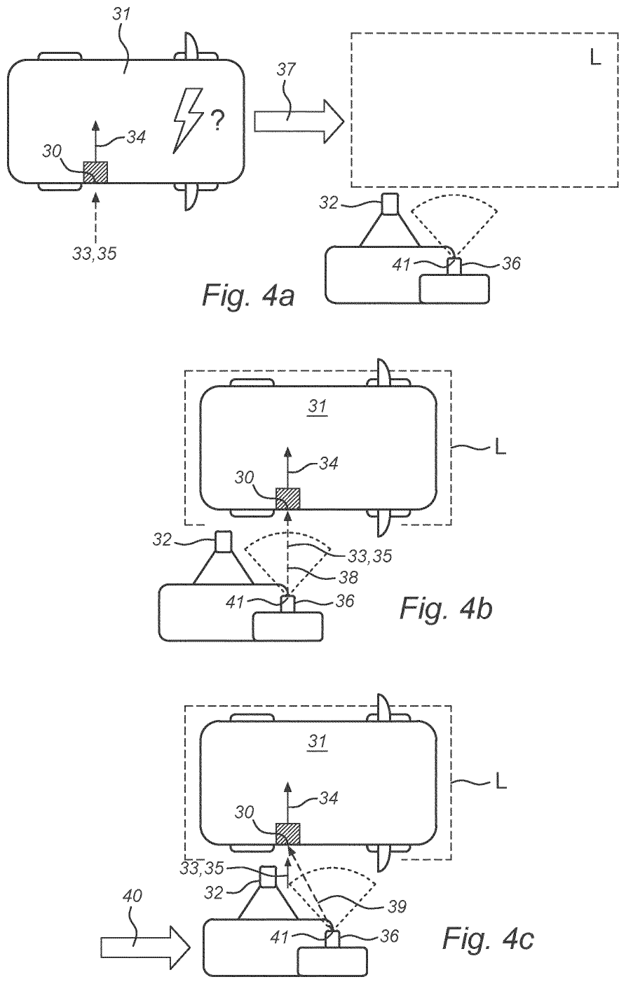

FIGS. 4a, b, c schematically show steps of a method according to the present invention.

FIG. 1a shows a front view of a vehicle socket 1 for receiving a charging connector. The vehicle socket has a geometry and features that can be recognized on a camera image. The actual image obtained by a camera depends on the socket's position and orientation with respect to the camera. In FIG. 1a the distance A between two connector holes for DC charging is indicated, as well as the distance B between one of the connector holes for DC charging and one of the connector holes for AC charging. Also, an angle alpha between two virtual crossing lines from holes for AC charging and holes for data connection is indicated, as well as a plug-in direction P (straight into the paper) and an axis of rotation C, about which the same socket 1 is depicted rotated over an angle in FIG. 1b.

FIG. 1b shows the same socket 1, rotated over an angle about axis of rotation C, seen from a camera which is not rotated with respect to FIG. 1a and with its pinhole in the same position. In FIG. 1b the distance A′ between two connector holes for DC charging is indicated, as well as the distance B′ between one of the connector holes for DC charging and one of the connector holes for AC charging. Also, an angle alpha′ between two virtual crossing lines from holes for AC charging and holes for data connection is indicated, as well as a plug-in direction P (with an angle with respect to the paper) and the axis of rotation C. Seen from the camera, the distance A′ is a lot smaller than the distance A, the Distance B′ is only a fraction smaller than B (because as a result of the rotation, the connector holes between which the distance B is indicated are a bit further from the camera, and the angle alpha has become larger. Given the known dimensions of a socket for a charger, with a 3D pose estimation algorithm it is possible to determine a position and/or orientation of the socket with respect to the camera pinhole.

In FIGS. 1a and b, for instance the centre of the cross X or the crossing of the arrow A and the axis C may be chosen as the optical gravity point.

FIGS. 2a-c each show a 2D camera 20, having a camera view 21 comprising view lines, each extending around a central view line 26 originating from a camera pinhole 27 within a maximum angle beta deviation around said central view line 26, adapted for providing a 2D image of a focal plane perpendicular to said central view line. Although the camera angle gamma between the central view line 26 and a line of sight from the camera pinhole 27 to the optical gravity point 28 on the socket is different in all situations, the line of sight 22 is always parallel to the plug in direction 24 for plugging in a charging connector into the socket.

FIGS. 3a-c show a similar situation, but now with orientations wherein an angle delta is obtained between the line of sight 26 and the plug in direction 24. This situation is comparable with FIG. 1b and allows to determine a socket position and orientation with a 3D pose estimation algorithm.

FIGS. 4a-c show subsequent steps of a method according to the invention for determining a position and orientation of a socket 30 of an electric vehicle 31, the socket 31 adapted for plugging in a charging connector 32 in one unique plug-in position 33 with one unique plug-in orientation and in one unique plug-in direction 34, as well as a front having an optical gravity point 35. A 2D camera 36 is provided with a view on a charging location L for the electric vehicle 31. The 2D camera has a camera view comprising view lines, each extending around a central view line originating from a camera pinhole within a maximum angle deviation around said central view line (see FIGS. 2a, b, c and 3a, b, c for a definition of terms which is also applicable for the situation depicted in FIGS. 4a-c) adapted for providing a 2D image with a focus on a plane perpendicular to said central view line. By moving the vehicle 31 in the direction 37, the socket 30 is brought within said camera view. As a next step, the camera 36 is moved in the direction of arrow 40 such that a view line 38, 39 (the line of sight) going through the optical gravity point on the socket is under an angle with the plug-in direction 34. In FIG. 4b this is not yet the case for line of sight 38, but in FIG. 4c, after moving the camera in direction 40, this is the case for line of sight 39. As a next step, the socket 30 is viewed with the camera 36 and a 2D image is obtained, for analysing with a 3D pose estimation algorithm for obtaining a position and/or orientation of the socket with respect to the camera pinhole 41. As a next step, the charging connector 32 may be plugged in automatically into the socket 30, based on its determined orientation and position.

The above described embodiments are examples only and do not limit the scope of protection of the invention as defined in the following claims.

1. Method for determining a position and orientation of a socket of an electric vehicle, the socket adapted for plugging in a charging connector in one unique plug-in position with one unique plug-in orientation and in one unique plug-in direction, the socket having a front plane with an optical gravity point; the method comprising:
providing a 2D camera with a view on a charging location for an electric vehicle; said 2D camera:
having a camera view comprising view lines, each extending around a central view line originating from a camera pinhole within a maximum angle deviation around said central view line;
adapted for providing a 2D image,
bringing the socket for plugging in a charging connector of the electric vehicle within said camera view;
defining a view line going through the optical gravity point on the socket as the line of sight;
viewing the socket with the camera and obtaining a 2D image;
analyzing the 2D image with a 3D pose estimation algorithm for obtaining a position and/or orientation of the socket with respect to the camera pinhole;
wherein
the vehicle and the camera are intentionally mutually positioned such that the line of sight is under an angle with the plug-in direction before obtaining the 2D image, which angle is maintained during obtaining the 2D image.

2. Method according to claim 1, wherein the angle is between 5 and 60 degrees

3. Method according to claim 1, wherein the optical gravity point on the socket is determined based on at least one purposive or purposeful fiducial marker.

4. Method according to claim 3, wherein the fiducial marker is formed by at least a part of the socket and/or a purposeful marker like a QR code, wherein the purposeful marker is located on a plane essentially parallel to the front plane.

5. Method according to claim 1, wherein an optical gravity point is a centroid of a convex hull of to-be-recognized features, wherein the to-be-recognized features are pins of the socket.

6. Method according to claim 1, wherein bringing the socket for plugging in a charging connector of the electric vehicle within said camera view, such that the line of sight is under an angle with the plug-in direction comprises at least one of:
positioning the vehicle at a predetermined position and/or orientation; and/or
moving the vehicle based on an estimated position and/or orientation of the vehicle; and/or
moving the camera based on an estimated position and/or orientation of the vehicle.

7. Method according to claim 6, wherein bringing the socket for plugging in a charging connector of the electric vehicle within said camera view, such that the line of sight is under an angle with the plug-in direction comprises moving the camera in an essentially straight line based on an estimated position and/or orientation of the vehicle.

8. Method according to claim 1 wherein the angle is between 7 and 45 degrees.

9. Method according to claim 1, wherein a single 2D recording is used for determining a position and/or orientation of the socket.

10. Method according to claim 1, comprising determining an average position and/or orientation of the socket based on multiple 2D images taken with both the socket and the camera in the same mutual position.

11. Method according to claim 6, wherein bringing the socket for plugging in a charging connector of the electric vehicle within said camera view, such that the line of sight is under an angle with the plug-in direction comprises moving the camera based on an estimated position and/or orientation of the socket, the method further comprising iteratively determining a socket position and orientation based on multiple 2D images taken with both the socket and the camera in different mutual positions, wherein the camera position and orientation for one 2D image is changed based on information derived from a previous 2D image for obtaining at least the intentional angle.

12. Method according to claim 11, wherein a distance between the 2D camera and the socket is decreased during iteration.

13. Method according to claim 1, comprising illuminating the socket.

14. Method according to claim 1, wherein the 2D image is further used for collision monitoring an area around the socket, in order to plug in a connector without collisions.

15. Method according to claim 1, comprising measuring a distance between the socket and a reference point, such as the camera or a connector.

16. Device for connecting a connector for charging an electric vehicle to a socket, comprising:
at least one 2D camera, positioned with a view on a charging location for an electric vehicle; said 2D camera:
having a camera view comprising view lines, each extending around a central view line originating from a camera pinhole within a maximum angle deviation around said central view line;
adapted for providing a 2D image, in particular with a focus on a plane perpendicular to said central view line;
processing means, configured for:
defining a line of sight being the view line going through the optical gravity point on the socket in case a vehicle with a socket for a charger connector is positioned within said camera view;
viewing a positioned socket with the camera and obtaining a 2D image;
analyzing the 2D image with a 3D pose estimation algorithm for obtaining a position and/or orientation of the socket with respect to the camera pinhole;
wherein
the processing means are configured for determining whether a vehicle and the camera are intentionally mutually positioned such that the line of sight is under an angle with a plug-in direction.

17. Device according to claim 16, comprising means for bringing the socket for plugging in a charging connector of the electric vehicle within said camera view, such as a marking of a parking spot, or physical stops, blocks, notches or similar limiters for a vehicle's movement, communication means for direct communication with the vehicle for providing parking instructions, or communication means for communication with a driver of the vehicle.

18. Device according to claim 16, wherein the means for bringing the socket of a vehicle for connecting a charging connector within said camera view comprise means for moving the camera.

19. Device according to claim 16, comprising a charging connector and means for positioning said charging connector.

20. Device according to claim 16, wherein the camera is mechanically coupled to the means for positioning the connector.

21. Device according to claim 16, wherein the camera is displaceable with respect to the connector.

22. Device according to claim 16, wherein the camera is rigidly placed with respect to the charging location, and/or wherein the processing means comprise communication means for sending drive or positioning instructions to a vehicle.

23. Device according to claim 16, comprising illumination means, such as a light source or spot, for illuminating the socket.

24. Device according to claim 16, configured for using the 2D image for collision monitoring of an area around the socket, in order to plug in a connector without collisions.

25. Device according to claim 16, comprising a distance sensor, for determining a distance between the socket and a reference point, such as the camera or a connector.
